(19) United States
(12) Patent Application Publication
(10) Pub. No.: US 2014/0123817 A1
(43) Pub. Date: May 8, 2014

(54) RATCHET WRENCH WITH A DIRECTIONAL SHIFTING STRUCTURE

(71) Applicant: Lai-Hao Lin, Taichung (TW)

(72) Inventor: Lai-Hao Lin, Taichung (TW)

(21) Appl. No.: 13/669,910

(22) Filed: Nov. 6, 2012

(51) Int. Cl. B25B 13/46

(52) U.S. Cl. CPC B25B 13/463
USPC 81/63.1

(57) ABSTRACT

A ratchet wrench with a directional shifting structure contains: a handle; a holder fixed on at least one end of the handle and having a first groove and a second groove; a first tool head secured in the first groove and having a first fitting portion and having a first toothed portion; a second tool head secured in the second groove o and having a second fitting portion and a second toothed portion; a first engaging block retained on the outer wall of the first tool head and having first teeth and a first push portion; a second engaging block retained on the outer wall of the second tool head and having second teeth and a second push portion; a control shaft axially fixed between the first engaging block and the second engaging block and having a first pushing peg and a second pushing peg.

### FIELD OF THE INVENTION

The present invention relates to a ratchet wrench with a directional shifting structure which allows simultaneously shifting an engaging direction of a first tool head and a second tool head by using a single control shaft so as to enhance using convenience and save production cost.

### BACKGROUND OF THE INVENTION

With reference to FIG. 1, a conventional ratchet wrench 10 contains a handle 11, and the handle 11 includes two first side extensions extending 111 outwardly from one end thereof and two second side extensions extending 112 outwardly from another end thereof, and between the two first side extensions 111 is axially disposed a first tool element 12, between the two second side extensions 112 is axially mounted a second tool element 13. In addition, the first tool element 12 has a first outer action end 121 and a first inner action end 122, the second tool element 13 has a second outer action end 131 and a second inner action end 132, wherein the first outer action end 121 and the first inner action end 122 have two polygonal holes in different diameters, and the second outer action end 131 and the second inner action end 132 have two polygonal holes in different diameters. Thereby, as locking or unlocking different sizes of bolts, the first tool element 12 and the second tool element 13 are rotated, the wrench tool is not replaced to another one, hence the first outer action end 121, the first inner action end 122, the second outer action end 131, and the second inner action end 132 are replaced so as to mate with the bolts in different sizes. However, the wrench tool 10 does not include a ratchet device, so it can not be idly rotated in a ratchet operating mode.

The foregoing, as well as additional objects, features and advantages of the invention will be more readily apparent from the following detailed description, which proceeds with reference to the accompanying drawings.

### SUMMARY OF THE INVENTION

The primary object of the present invention is to provide a ratchet wrench with a directional shifting structure which allows simultaneously shifting an engaging direction of a first tool head and a second tool head, such that as locking or unlocking the bolt, the first tool head and the second tool head idly rotate in so that the handle is rotated repeatedly in a ratchet operating mode, thus enhancing using convenience.

Further object of the present invention is to provide a ratchet wrench with a directional shifting structure which allows simultaneously shifting the engaging direction of the first tool head and the second tool head by using a single control shaft so as to save production cost.

Another object of the present invention is to provide a ratchet wrench with a directional shifting structure which allows simultaneously shifting the engaging direction of a third first tool head and a fourth tool head so as to be applicable for different sizes of bolts, thus avoiding repeated replacement of bolts in different sizes.

To obtain the above objective, a ratchet wrench with a directional shifting structure provided by the present invention contains:
a handle;
a holder fixed on at least one end of the handle and having a first groove and a second groove, both of which are formed in the holder;
a first tool head secured in the first groove of the holder and having a first fitting portion defined therein and having a first toothed portion formed around an outer wall thereof;
a second tool head secured in the second groove of the holder and having a second fitting portion defined therein and having a second toothed portion formed around an outer wall thereof;
a first engaging block retained on the outer wall of the first tool head and having a plurality of first teeth formed on one side thereof and a first push portion defined on another end of the first engaging block;
a second engaging block retained on the outer wall of the second tool head and having a plurality of second teeth formed on one side thereof and a second push portion defined on another end of the second engaging block;
a control shaft axially fixed between the first engaging block and the second engaging block and having a first pushing peg for pushing the first push portion of the first engaging block and having a second pushing peg for pushing the second push portion of the second engaging block, such that the first engaging block and the second engaging block are pushed by the first pushing peg and the second pushing peg to move.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional wrench tool.

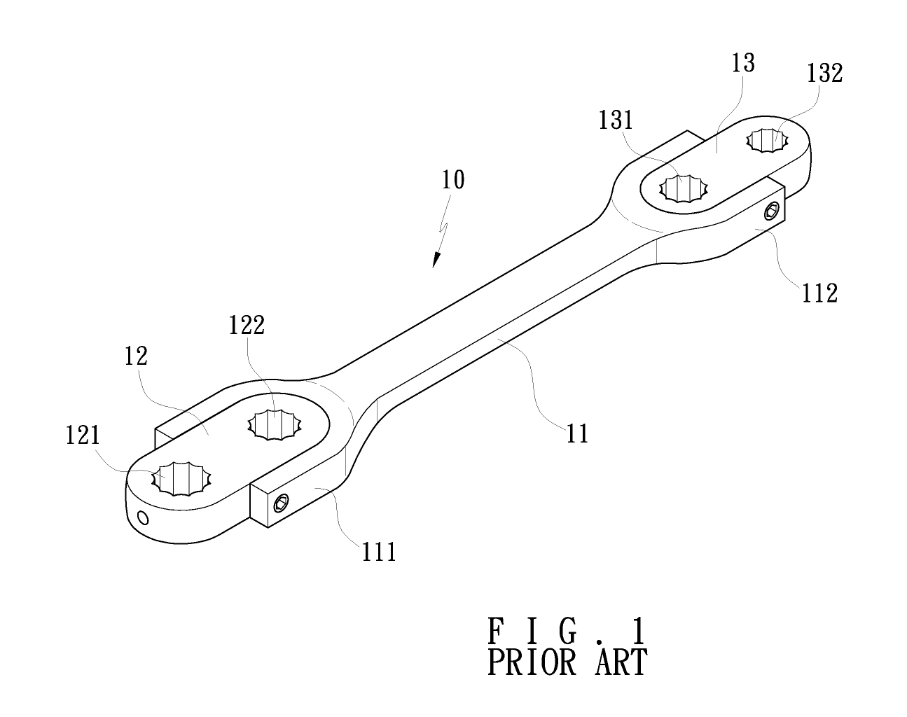

FIG. 2 is a perspective view showing the exploded components of a ratchet wrench with a directional shifting structure according to a preferred embodiment of the present invention.

FIG. 3 is another perspective view showing the exploded components of the ratchet wrench with the directional shifting structure according to the preferred embodiment of the present invention.

FIG. 4 is a perspective view showing the assembly of the ratchet wrench with the directional shifting structure according to the preferred embodiment of the present invention.

FIG. 5 is a cross sectional view showing the assembly of the ratchet wrench with the directional shifting structure according to the preferred embodiment of the present invention.

FIG. 6 is a perspective view showing the operation of the ratchet wrench with the directional shifting structure according to the preferred embodiment of the present invention.

FIG. 7 is a cross sectional view showing the operation of the ratchet wrench with the directional shifting structure according to the preferred embodiment of the present invention.

FIG. 8 is another cross sectional view showing the operation of the ratchet wrench with the directional shifting structure according to the preferred embodiment of the present invention.

FIG. 9 is also another cross sectional view showing the operation of the ratchet wrench with the directional shifting structure according to the preferred embodiment of the present invention.

FIG. 10 is a plan view showing the operation of the ratchet wrench with the directional shifting structure according to the preferred embodiment of the present invention.

FIG. 11 is still another cross sectional view showing the operation of the ratchet wrench with the directional shifting structure according to the preferred embodiment of the present invention.

FIG. 12 is another plan view showing the operation of the ratchet wrench with the directional shifting structure according to the preferred embodiment of the present invention.

FIG. 13 is a perspective view showing the operation of the ratchet wrench with the directional shifting structure according to the preferred embodiment of the present invention.

### DETAILED DESCRIPTION OF THE PREFERRED EMBODIMENTS

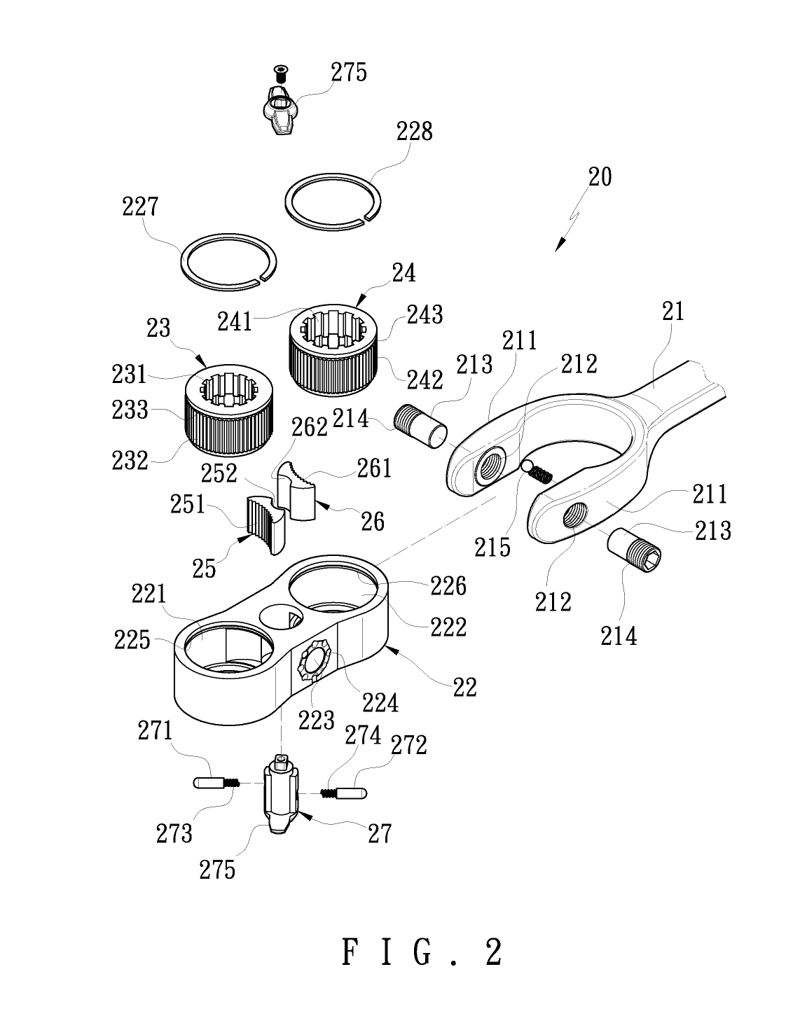

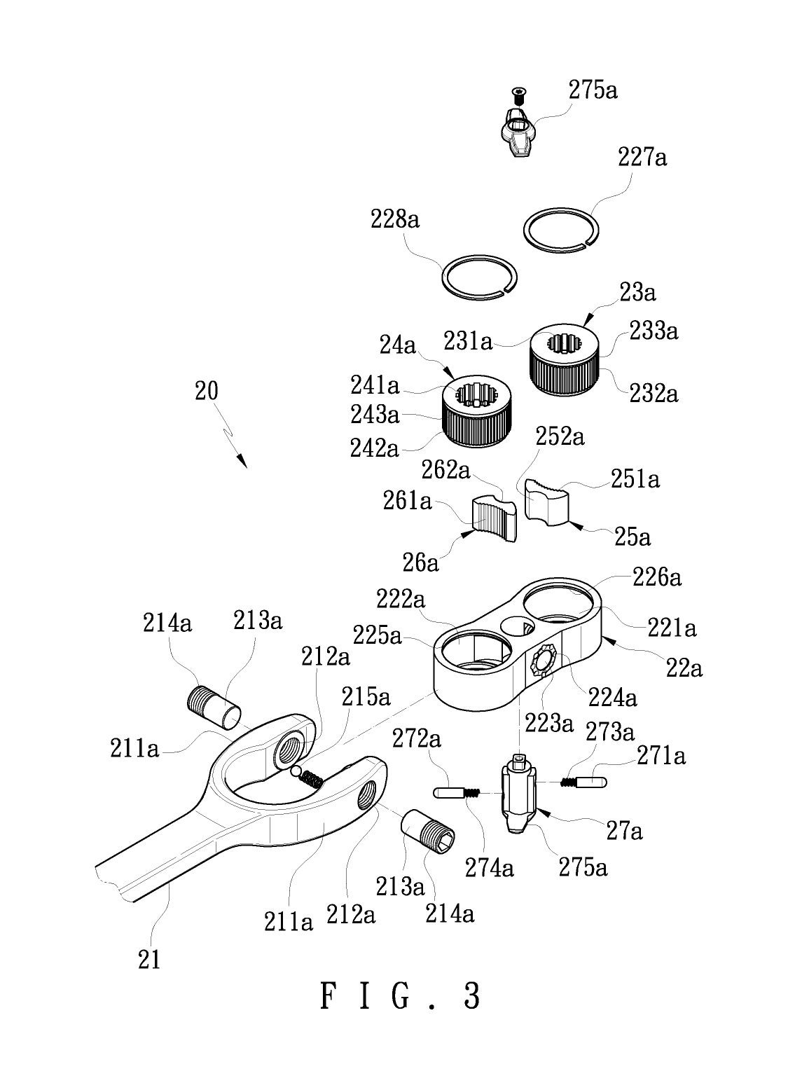

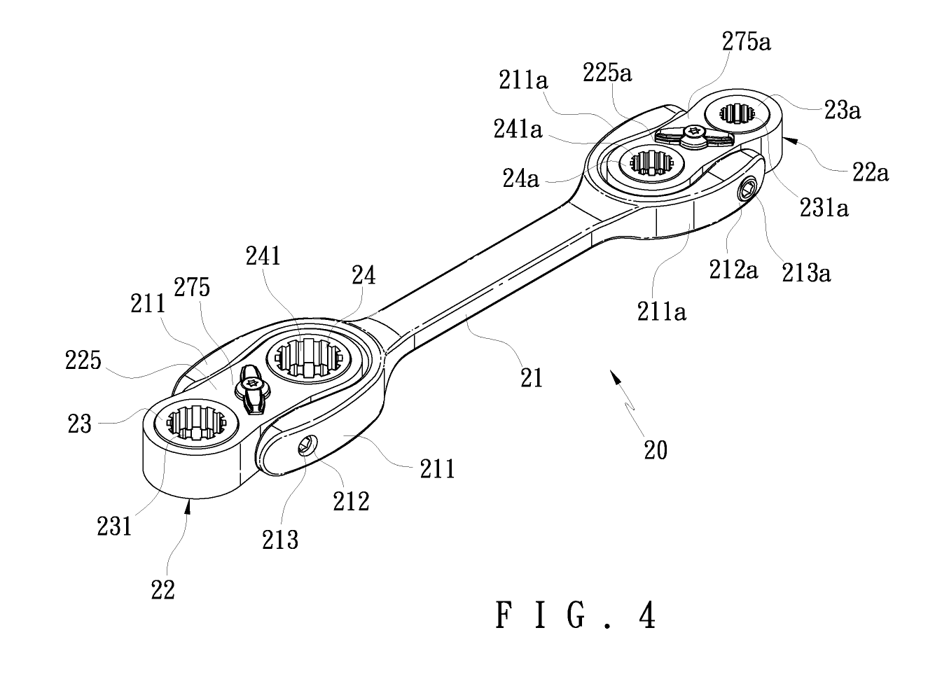

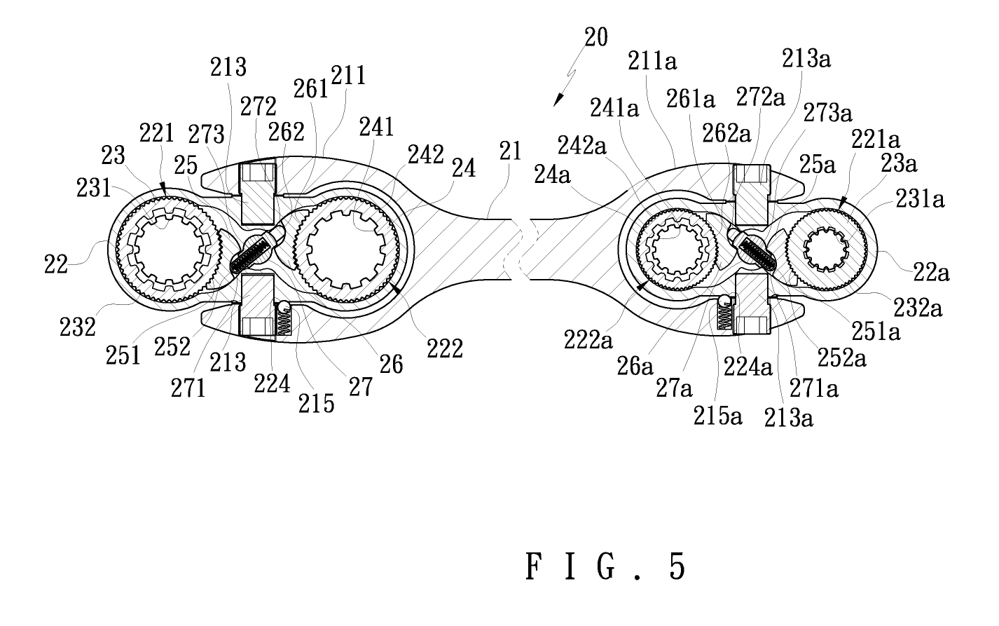

With reference to FIGS. 2-5, a ratchet wrench 20 with a directional shifting structure according to a preferred embodiment of the present invention comprises a handle 21, the handle 21 includes two side extensions 211 extending outwardly from one end thereof and a receiving space defined between the two side extensions 211 so as to receive a holder 22 in which a first groove 221 and a second groove 222 are formed, and among the holder 22 and the two side extensions 211 of the handle 21 is defined an axial rotating structure so as to axially rotate the holder 22 between the two side extensions 211. In this embodiment, the axial rotating structure includes two holes 223 defined on two sides of the holder 22 and includes two threaded orifices 212 formed on the two side extensions 211 of the handle 21 so as to screw with two threaded sections 214 of two stems 213 of the one end of the handle 21, such that two end portions of the two stems 213 insert into the two holes 223 of the holder 22, hence the two stems 213 axially position the holder 22. Also, among the holder 22 and the two side extensions 211 of the handle 21 is defined a positioning structure so as to fix the holder 22. In this embodiment, the positioning structure includes a plurality of fixing slots 224 arranged around the two holes 223 of the holder 22 and includes two steel balls 215 disposed in two inner surfaces of the two side extensions 211 of the handle 21 so as to retain with a respective one of the plurality of fixing slots 224. The first groove 221 of the holder 22 has a first tool head 23 secured therein, and the first tool head 23 has a first fitting portion 231 defined therein and a first toothed portion 232 formed around an outer wall thereof. The second groove 222 of the holder 22 includes a second tool head 24 secured therein, and the second tool head 24 has a second fitting portion 241 defined therein and a second toothed portion 242 formed around an outer wall thereof, wherein the first fitting portion 231 of the first tool head 23 and the second fitting portion 241 of the second tool head 24 have two apertures formed thereon and having two different diameters so as to fit two bolts for mating with the two apertures of the first fitting portion 231 and the second fitting portion 241, and wherein the first tool head 23 and the second tool head 24 are limited in the first groove 221 and the second groove 222 by ways of a limiting structure. In this embodiment, the limiting structure includes a first annular recess 225 defined in the first groove 221, a second annular recess 226 defined in the second groove 222, a third annular recess 233 formed on the first tool head 23, and a fourth annular recess 243 arranged on the second tool head 24, wherein the first tool head 23 is limited in the first groove 221 of the holder 22 by using a first retaining ring 227, and the second tool head 24 is limited in the second groove 222 of the holder 22 by using a second retaining ring 228. The first tool head 23 also has a first engaging block 25 retained on the outer wall thereof, the first engaging block 25 has a plurality of first teeth 251 formed on one side thereof so as to mesh with and drive the first toothed portion 232 of the first tool head 23 and has a first push portion 252 formed in a concave arcuation shape and defined on another end thereof, the second tool head 24 also has a second engaging block 26 retained on the outer wall thereof, the second engaging block 26 has a plurality of second teeth 261 formed on one side thereof so as to mesh with the second toothed portion 242 of the second tool head 24 and has a second push portion 262 formed in a concave arcuation shape and defined on another end thereof. Between the first engaging block 25 and the second engaging block 26 is axially fixed a control shaft 27, and the control shaft 27 has a first pushing peg 271 disposed on one end thereof so as to push the first push portion 252 of the first engaging block 25 and has a second pushing peg 272 disposed on another end thereof so as to push the second push portion 262 of the second engaging block 26; wherein the first pushing peg 271 and the second pushing peg 272 have a first resilient element 273 (such as a spring) and a second resilient element 274 (such as a spring) so as to push the first pushing peg 271 and the second pushing peg 272 outwardly. The control shaft 27 also has two actuation pieces 275 mounted on two ends thereof which extend out of the holder 22 so as to rotate the control shaft 27, and the first pushing peg 271 and the second pushing peg 272 push the first engaging block 25 and the second engaging block 26 to move.

The handle 21 also includes another two side extensions 211a extending outwardly from another end thereof, and between the another two side extensions 211a is fixed another holder 22a in which a first groove 221a and a second groove 222a are formed, and between the another holder 22a and the another two side extensions 211a of the handle 21 is defined an axial rotating structure so as to axially rotate the holder 22a between the another two side extensions 211a. In this embodiment, the axial rotating structure includes two holes 223a defined on two sides of the another holder 22s and includes two threaded orifices 212a formed on the another two side extensions 211a of the handle 21 so as to screw with two threaded sections 214a of two stems 213a of the another one end of the handle 21, such that two end portions of the two stems 213 insert into the two holes 223a of the holder 22a, hence the two stems 213 axially fix the holder 22a. Also, among the another holder 22a and the another two side extensions 211a of the handle 21 is defined a positioning structure so as to position the another holder 22. In this embodiment, the positioning structure includes a plurality of fixing slots 224a arranged around the two holes 223a of the another holder 22a and includes two steel balls 215a disposed in two inner surfaces of the another two side extensions 211a of the handle 21 so as to retain with a respective one of the plurality of fixing slots 224a. The first groove 221a of the another holder 22a has a third tool head 23a secured therein, and the third tool head 23a has a first fitting portion 231a defined therein and a first toothed portion 232a formed around an outer wall thereof. The second groove 222a of the another holder 22a includes a fourth tool head 24a secured therein, and the fourth tool head 24a has a second fitting portion 241a defined therein and a second toothed portion 242s formed around an outer wall thereof, wherein the first fitting portion 231a of the third tool head 23a and the second fitting portion 241a of the fourth tool head 24a have two apertures formed thereon and having two different diameters so as to fit two bolts for mating with the two apertures of the first fitting portion 231a and the second fitting portion 241a, and the third tool head 23a and the fourth tool head 24a are limited in the first groove 221a and the second groove 222a by ways of a limiting structure. In this embodiment, the limiting structure includes a first annular recess 225a defined in the first groove 221a, a second annular recess 226a defined in the second groove 222a, a third annular recess 233a formed on the third tool head 23a, and a fourth annular recess 243a arranged on the fourth tool head 24a, wherein the third tool head 23s is limited in the first groove 221a of the another holder 22a by using a first retaining ring 227a, and the fourth tool head 24a is limited in the second groove 222a of the another holder 22 by using a second retaining ring 228a. The first third head 23a also has a third engaging block 25a retained on the outer wall thereof, the third engaging block 25a has a plurality of third teeth 251a formed on one side thereof so as to mesh with and drive the first toothed portion 232a of the third tool head 23a and has a first push portion 252a formed in a concave arcuation shape and defined on another end thereof, and the fourth tool head 24a also has a fourth engaging block 26a retained on the outer wall thereof, the fourth engaging block 26a has a plurality of second teeth 261a formed on one side thereof so as to mesh with the second toothed portion 242a of the fourth tool head 24 and has a second push portion 262a formed in a concave arcuation shape and defined on another end thereof. Between the third engaging block 25a and the fourth engaging block 26a is axially fixed another control shaft 27, and the another control shaft 27a has a third pushing peg 271a disposed on one end thereof so as to push the push portion 252a of the third engaging block 25a and has a fourth pushing peg 272a disposed on another end thereof so as to push the second push portion 262a of the fourth engaging block 26a; wherein the third pushing peg 271a and the fourth pushing peg 272a have a first resilient element 273a (such as a spring) and a second resilient element 274a (such as a spring) so as to push the third pushing peg 271a and the fourth pushing peg 272a outwardly. The another control shaft 27a also has two actuation pieces 275a mounted on two ends thereof which extend out of the another holder 22a so as to rotate the another control shaft 27a, and the third pushing peg 271a and the fourth pushing peg 272a push the third engaging block 25a and the fourth engaging block 26a to move.

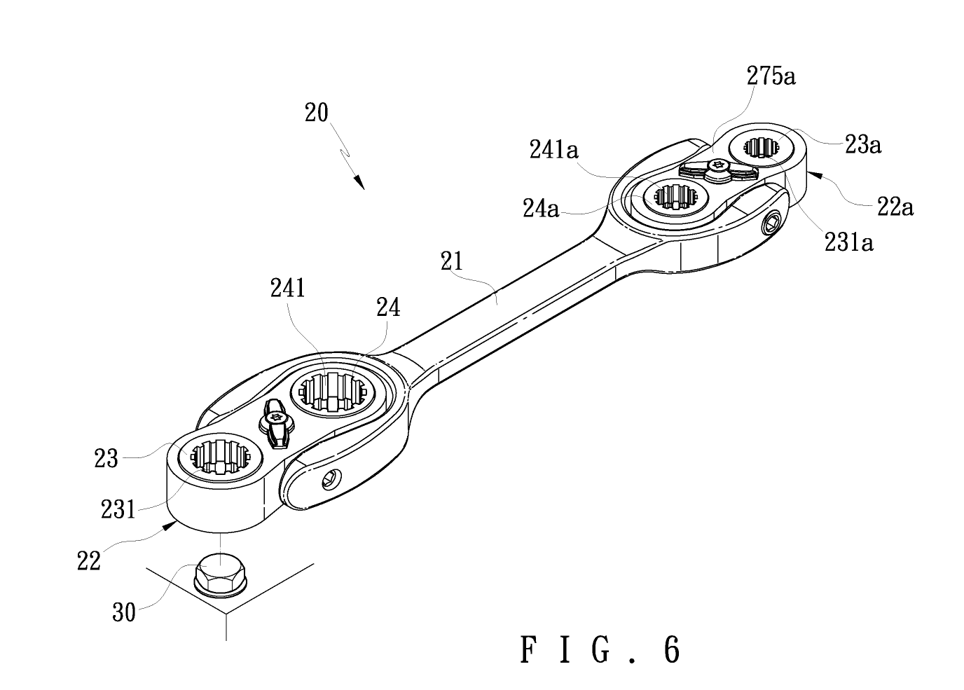

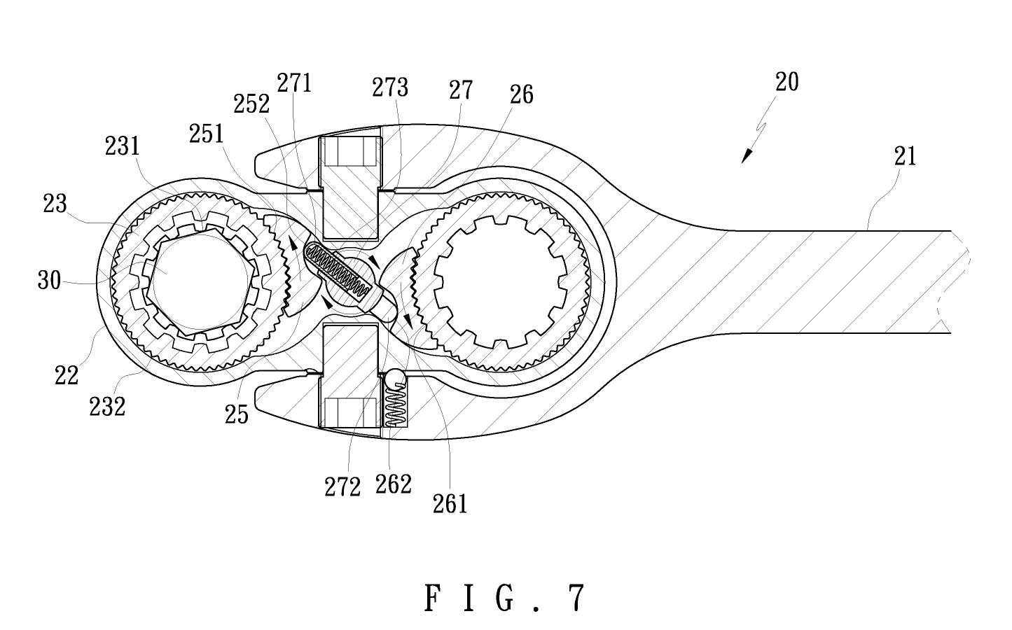

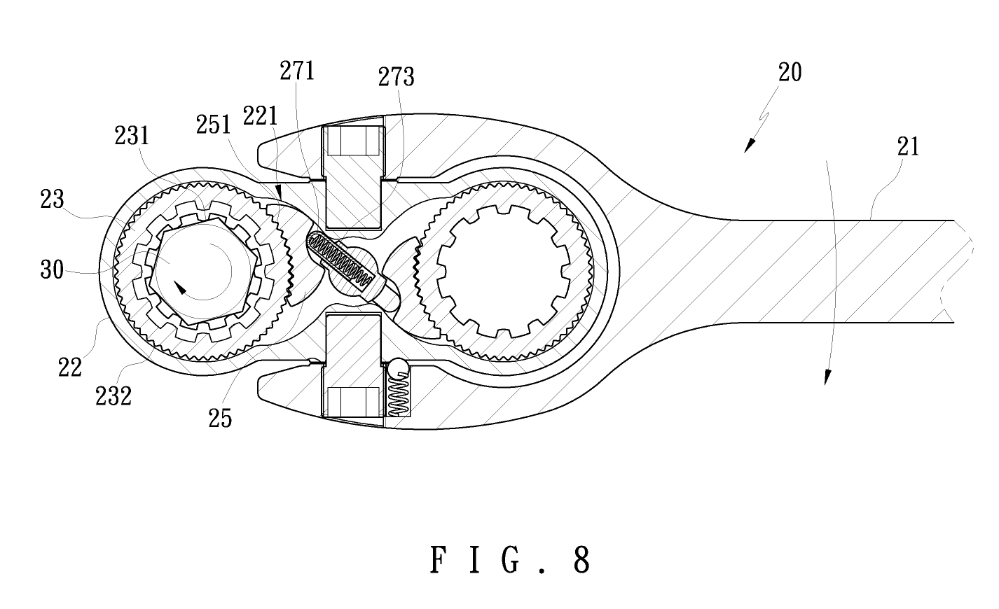

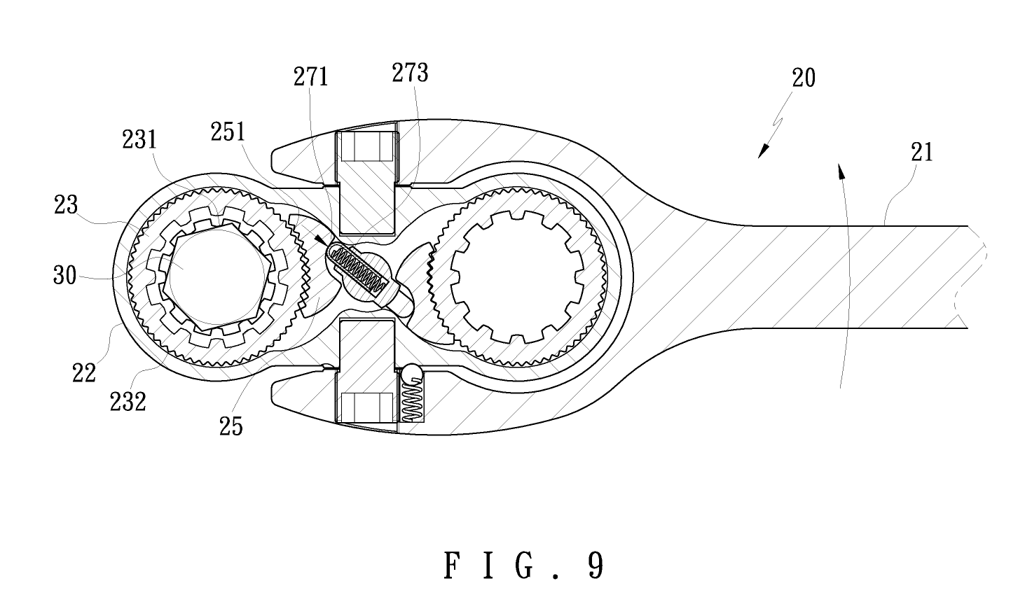

Referring further to FIGS. 6 and 7, the handle 21 includes the first tool head 23 and the second tool head 24 fixed on the one end thereof and includes the third tool head 23a and the fourth tool head 24a disposed on the another end thereof so as to lock or unlock the bolt, thus having a lock and unlock operation. In addition, the first tool head 23, the second tool head 24 and the third tool head 23a, the fourth tool head 24a shift an locking direction simultaneously by means of the control shaft 27 and the another control shaft 27a, thus enhancing using convenience. For example, when locking a bolt 30, the two actuation pieces 275 are rotated to rotate the control shaft 27 clockwise, and the first pushing peg 271 of the control shaft 27 pushes the first push portion 252 of the first engaging block 25 so that the first engaging block 25 moves, and the second pushing peg 272 of the control shaft 27 pushes the second push portion 262 of the second engaging block 26 so that the second engaging block 26 moves, hence the first fitting portion 231 of the first tool head 23 fits on the bolt 31. As shown in FIG. 8, the handle 21 is further rotated clockwise, the first groove 221 of the first groove 221 pushes the first engaging block 25, and the plurality of first teeth 251 of the first engaging block 25 mesh with and drive the first toothed portion 232 of the first tool head 23 so that the first fitting portion 231 of the first tool head 23 rotatably locks the bolt 30 clockwise. As illustrated in FIG. 9, as rotating the handle 21 anticlockwise, the first toothed portion 232 of the tool head 23 pushes the plurality of first teeth 251 of the first engaging block 25, and the first push portion 252 of the first engaging block 25 pushes the pushing peg 271 of the control shaft 27 to retract inwardly so that the handle 21 idly rotates anticlockwise so that the handle 21 is rotated repeatedly in a ratchet operating mode, thus locking the bolt 30 quickly.

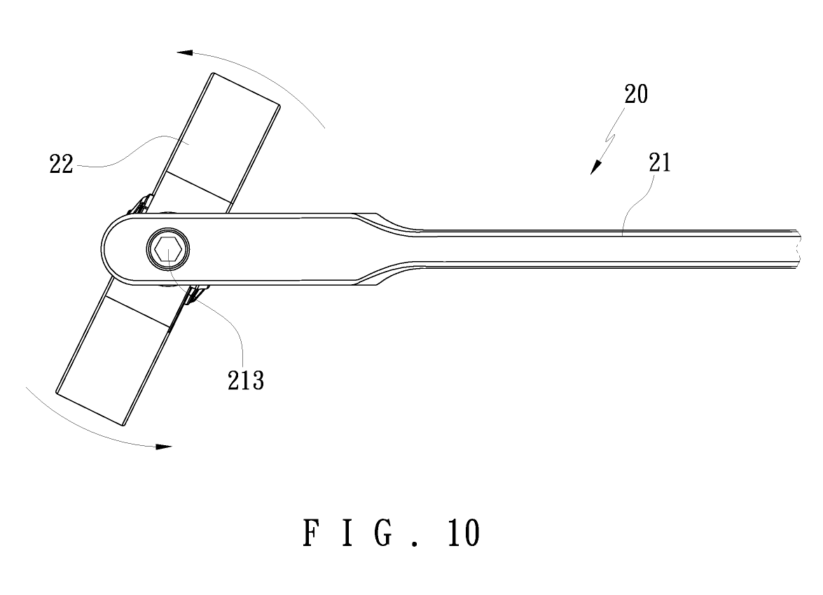

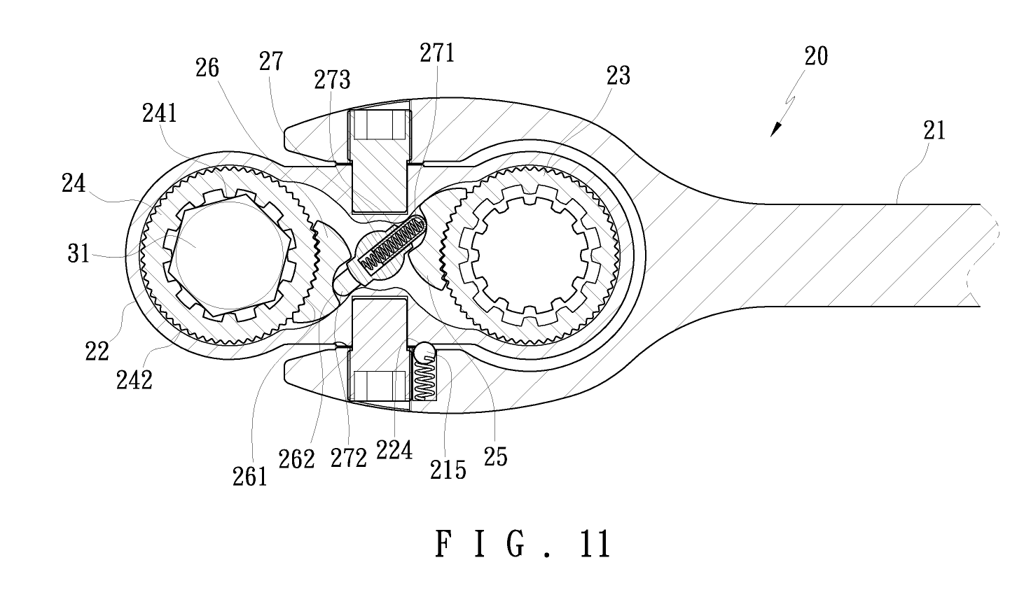

With reference to FIGS. 10 and 11, in lock or unlock operation, if desiring to use the second tool head 24, the holder 22 is rotated 180 degrees, and the two steel balls 215 retain another one of the plurality of fixing slots 224 so that the second tool head 24 and the first tool head 23 change their positions with each other. i.e., the second tool head 24 is fitted on another bolt 31, and the handle 21 is rotated repeatedly in the ratchet operating mode, thus locking the another bolt 30 quickly.

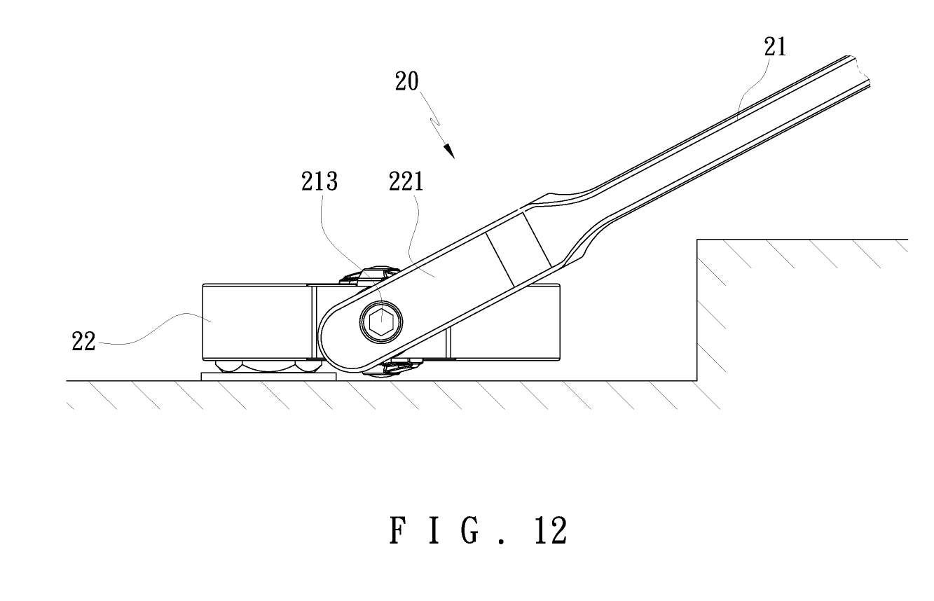

As shown in FIG. 12, when operating the ratchet wrench in a narrow space, the handle 21 axially rotates a suitable angle and the handle 21 is fixed by the positioning structure so as to rotate the handle 21 further, this assembling or disassembling the bolt.

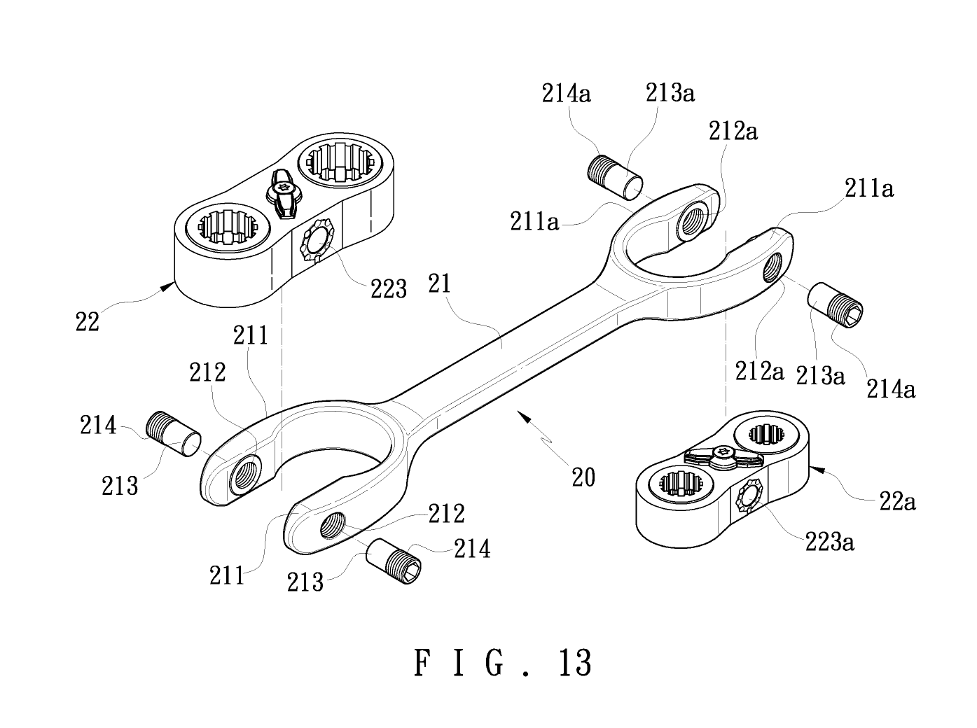

As illustrated in FIG. 13, the two stems 213, 213a of the handle 21 are rotated so as to further remove from the two holes 223 of the holder 22 and the two holes 223a of the another holder 22a, thus disassembling two holders 22, 22a so that other tool heads in different sizes are replaced onto two ends of the handle 21 so as to lock and unlock different sizes of bolts.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A ratchet wrench with a directional shifting structure comprising:
a handle;
a holder fixed on at least one end of the handle and having a first groove and a second groove, both of which are formed in the holder;
a first tool head secured in the first groove of the holder and having a first fitting portion defined therein and having a first toothed portion formed around an outer wall thereof;
a second tool head secured in the second groove of the holder and having a second fitting portion defined therein and having a second toothed portion formed around an outer wall thereof;
a first engaging block retained on the outer wall of the first tool head and having a plurality of first teeth formed on one side thereof and a first push portion defined on another end of the first engaging block;
a second engaging block retained on the outer wall of the second tool head and having a plurality of second teeth formed on one side thereof and a second push portion defined on another end of the second engaging block;
a control shaft axially fixed between the first engaging block and the second engaging block and having a first pushing peg for pushing the first push portion of the first engaging block and having a second pushing peg for pushing the second push portion of the second engaging block, such that the first engaging block and the second engaging block are pushed by the first pushing peg and the second pushing peg to move.

2. The ratchet wrench with the directional shifting structure as claimed in claim 1, wherein the handle includes two side extensions extending outwardly from the at least one end thereof and a receiving space defined between the two side extensions so as to receive the holder.

3. The ratchet wrench with the directional shifting structure as claimed in claim 2, wherein among the holder and the two side extensions of the handle is defined an axial rotating structure so that the holder axially rotates between the two side extensions.

4. The ratchet wrench with the directional shifting structure as claimed in claim 3, wherein the axial rotating structure includes two holes define on two sides of the holder and two threaded orifices formed on the two side extensions of the handle so as to screw with two threaded sections of two stems so that two end portions of the two stems insert into the two holes of the holder, such that the two stems axially position the holder.

5. The ratchet wrench with the directional shifting structure as claimed in claim 4, wherein among the holder and the two side extensions of the handle is defined a positioning structure so as to fix the holder.

6. The ratchet wrench with the directional shifting structure as claimed in claim 5, wherein the positioning structure includes a plurality of fixing slots arranged around the two holes of the holder and includes two steel balls disposed in two inner surfaces of the two side extensions of the handle so as to retain with a respective one of the plurality of fixing slots.

7. The ratchet wrench with the directional shifting structure as claimed in claim 1, wherein the first push portion of the first engaging block and the second push portion of the second engaging block are formed in a concave arcuation shape.

8. The ratchet wrench with the directional shifting structure as claimed in claim 1, wherein the first tool head and the second tool head are limited in the first groove and the second groove by ways of a limiting structure, the limiting structure includes a first annular recess defined in the first groove, a second annular recess defined in the second groove, a third annular recess formed on the first tool head, and a fourth annular recess arranged on the second tool head, and wherein the first tool head is limited in the first groove of the holder by using a first retaining ring, and the second tool head is limited in the second groove of the holder by using a second retaining ring.

9. The ratchet wrench with the directional shifting structure as claimed in claim 1, the control shaft has a first pushing peg disposed on one end thereof so as to push the first push portion of the first engaging block and has a second pushing peg disposed on another end thereof so as to push the second push portion of the second engaging block; wherein the first pushing peg and the second pushing peg have a first resilient element and a second resilient element so as to push the first pushing peg and the second pushing peg outwardly.

10. The ratchet wrench with the directional shifting structure as claimed in claim 1, wherein the control shaft also has two actuation pieces mounted on two ends thereof which extend out of the holder.
